(19) United States
(12) Patent Application Publication
(10) Pub. No.: US 2016/0277772 A1
(43) Pub. Date: Sep. 22, 2016

(54) REDUCED BIT RATE IMMERSIVE VIDEO

(71) Applicant: TELEFONAKTIEBOLAGET L M ERICSSON (PUBL), Stockholm (SE)

(72) Inventors: Alistair CAMPBELL, Southhampton, Hampshire (GB); Pedro TORRUELLA, Southhampton, Hampshire (GB)

(73) Assignee: Telefonaktiebolaget L M Ericsson (publ), Stockholm (SE)

(21) Appl. No.: 14/413,336

(22) PCT Filed: Sep. 30, 2014
(86) PCT No.: PCT/EP2014/070936

§ 371 Date: Jan. 7, 2015

(51) Int. Cl. H04N 21/218; G06T 19/00; H04N 21/47; H04N 21/2343; H04N 21/4728; H04N 21/6587

(52) U.S. Cl. CPC H04N 21/21805; H04N 21/4728; H04N 21/6587; H04N 21/47; H04N 21/234381; G06T 19/006

(57) ABSTRACT

A user terminal arranged to: select a subset of video segments each relating to a different area of a field of view; retrieve the selected video segments; knit the selected segments together to form a knitted video image that is larger than a single video segment; and output the knitted video image.

### TECHNICAL FIELD

The present application relates to a user terminal, an apparatus arranged to display a portion of a large video image, a video processing apparatus, a transmission apparatus, a method in a video processing apparatus, a method of processing retrieved video segments, a computer-readable medium, and a computer-readable storage medium.

### BACKGROUND

Immersive video describes a video of a real world scene, where the view in multiple directions is viewed or is at least viewable at the same time. Immersive video is sometimes described as recording the view in every direction, sometimes with a caveat excluding the camera support. Strictly interpreted, this is an unduly narrow definition, and in practice the term immersive video is applied to any video with a very wide field of view.

Immersive video can be thought of as video where a viewer is expected to watch only a portion of the video at any one time. For example, the IMAX® motion picture film format, developed by the IMAX Corporation provides very high resolution video to viewers on a large screen where it is normal that at any one time some portion of the screen is outside of the viewer's field of view. This is in contrast to a smartphone display or even a television, where usually a viewer can see the whole screen at once.

U.S. Pat. No. 6,141,034 to Immersive Media, describes a system for dodecahedral imaging. this is used for the creation of extremely wide angle images. This document describes the geometry required to align camera images. Further, standard cropping mattes for dodecahedral images are given, and compressed storage methods are suggested for a more efficient distribution of dodecahedral images in a variety of media.

U.S. Pat. No. 3,757,040 to The Singer Company describes a wide angle display for digitally generated information. In particular the document describes how to display an image stored in planar form onto a non-planar display.

### SUMMARY

Immersive video experiences have long been limited to specialist hardware. Further, and possibly as a result of the hardware restrictions, mass delivery of immersive video has not been required. However, with the advent of modern smart devices, and more affordable specialist hardware, there is scope for streamed immersive video delivered ubiquitously in much the same way that streamed video content is now prevalent.

However, delivery of a total field of view of a scene just for a user to select a small portion of it to view is an inefficient use of resources. The methods and apparatus described herein provide for the splitting of a video view of a scene into video segments, and allowing the user terminal to select the video segments to retrieve. Thus a much more efficient delivery mechanism is realized. This allows for reduced network resource consumption, or improved video quality for a given network resource availability, or a combination of the two.

Accordingly, there is provided a user terminal arranged to select a subset of video segments each relating to a different area of a field of view. The user terminal is further arranged to retrieve the selected video segments, and to knit the selected segments together to form a knitted video image that is larger than a single video segment. The user terminal is further still arranged to output the knitted video image.

Even when the entire area of an immersive video is projected around a viewer, they are only able to focus at a portion of the video at one time. With modern viewing methods using a handheld device like a smartphone or a virtual reality headset, only a portion of the video is displayed at any one time.

By allowing the user terminal to select and retrieve only the segments of an immersive video required that are currently required for display to the viewer, the amount of information that the user terminal must retrieve and process to display the immersive video is reduced.

The user terminal may be arranged to select a subset of video segments, each segment relating to a different field of view taken from a common location. Alternatively, the video segments selected by the user terminal may each relate to a different field of view taken from a different location. In such an arrangement each segment relates to a different point of view. Transitioning from one segment to another may give the impression of a camera moving within the world. The cameras and locations may reside in either the real or virtual worlds.

The plurality of video segments relating to the total available field of view may be encoded at different quality levels, and the user terminal may further select a quality level of each selected video segment that is retrieved.

The quality level of an encoded video segment may be determined by the bit rate, the quantization parameter, or the pixel resolution. A lower quality segment should require fewer resources for transmission and processing. By making segments available at different quality levels, a user terminal can adapt the amount of network and processing resources it uses in the same way as adaptive video streaming, such as HTTP adaptive streaming.

The selection of a subset of video segments may be defined by a physical location and/or orientation of the user terminal. Alternatively, the selection may be defined by a user input to the user terminal. Such a user input may be via a touch screen on the user terminal, or some other touch sensitive surface.

The selection of a subset of video pixels may be defined by user input to a controller connected to the user terminal. The user selection may be defined by a physical location and/or orientation of the controller. The user terminal may comprise at least one of a smart phone, tablet, television, set top box, or games console.

The user terminal may be arranged to display a portion of a large video image. The large video image may be an immersive video, a 360 degree video, or a wide-angled video.

There is further provided an apparatus arranged to display a portion of a large video image, the apparatus comprising a processor and a memory, said memory containing instructions executable by said processor whereby said apparatus is operative to select a subset of video segments each relating to a different area of a field of view, and to retrieve the selected video segments. The apparatus is further operative to knit the selected segments together to form a knitted video image that is larger than a single video segment; and to output the knitted video image.

There is further provided a video processing apparatus arranged to receive a video stream, and to slice the video stream into a plurality of video segments, each video segment relating to a different area of a field of view of the received video stream. The video processing apparatus is arranged to encode each video segment.

By splitting an immersive video into segments and encoding each segment separately, the video processing apparatus creates a plurality of discrete files suitable for subsequent distribution to a user terminal whereby only the tiles that are needed to fill a current view of the user terminal are sent to the user terminal. This reduces that amount of information that the user terminal must retrieve and process for a particular section or view of the immersive video to be shown.

The video processing apparatus may output the encoded video segments. The video processing apparatus may output all encoded video segments to a server, for subsequent distribution to at least one user apparatus. Alternatively, the video processing apparatus may output video segments selected by a user terminal to that user terminal.

The video processing apparatus may have a record of the popularity of each video segment. The popularity of particular segments, and how this varies with time can be used to target the encoding effort on the more popular segments. This will give a better quality experience to the majority of users for a given amount of resources. The popularity may comprise an expected value of popularity, a statistical measure of popularity, and/or a combination of the two. The received video stream may comprise live content or pre-recorded content, and the popularity of these may be measured in different ways.

The video processing apparatus may apply more compression effort to the video segments having the highest popularity. A greater compression effort results in a more efficiently compressed video segment. However, increased compression effort requires more processing such as multiple pass encoding. In many situations, applying such resource intensive video processing to the low popularity segments will be an inefficient use of resources.

The video stream may be sliced into a plurality of video segments dependent upon the content of the video stream.

The video processing apparatus may have a record of the popularity of each video segment, and whereby popular video segments relating to adjacent fields of view are combined into a single larger video segment. Larger video segments might be encoded more efficiently, as the encoder has a wider choice of motion vectors, meaning that an appropriate motion vector candidate is more likely to be found. Popular video segments relating to adjacent fields of view are likely to be requested together. The video processing apparatus may alternatively keep a record of video segments that are downloaded together and combine video segments accordingly.

Each video segment may be assigned a commercial weighting, and more compression effort is applied to the video segments having the highest commercial weighting. The commercial weighting of a video segment may be determined by the presence of an advertisement in the segment.

There is further provided a transmission apparatus arranged to receive a selection of video segments from a user terminal, the selected video segments suitable for being knitted together to create an image that is larger than a single video segment. The transmission apparatus is further arranged to transmit the selected video segments to the user device. The transmission apparatus may be a server.

The transmission apparatus may be further arranged to record which video segments are requested for the gathering of statistical information.

There is further provided a method in a video processing apparatus. The method comprises receiving a video stream, and separating the video stream into a plurality of video segments, each video segment relating to a different area of a field of view of the received video stream. The method further comprises encoding each video segment

There is further provided a method of processing retrieved video segments. This method may be performed in the user apparatus described above. The method comprises making a selection a subset of the available video segments. The selection may be based on received user input or device status information. The method further comprises retrieving the selected video segments, and knitting these together to form a knitted video image that is larger than a single video segment. The knitted video image is then output to the user.

There is further still provided a computer-readable medium, carrying instructions, which, when executed by computer logic, causes said computer logic to carry out any of the methods defined herein.

There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

### BRIEF DESCRIPTION OF THE DRAWINGS

A method and apparatus for reduced bit rate immersive video will now be described, by way of example only, with reference to the accompanying drawings, in which:

FIG. 1 illustrates a user terminal displaying a portion of an immersive video;

FIG. 2 shows a man watching a video on his smartphone;

FIG. 3 shows a woman watching a video on a virtual reality headset;

FIG. 4 illustrates an arrangement wherein video segments each relate to a different field of view taken from a different location;

FIG. 5 shows a portion of a video that has been sliced up into a plurality of video segments;

FIG. 6 illustrates a change in selection of displayed video area, different to that of FIG. 5;

FIG. 7 illustrates an apparatus arranged to output a portion of a large video image;

FIG. 8 illustrates a video processing apparatus;

FIG. 9 illustrates a method in a video processing apparatus;

FIG. 10 illustrates a method of processing retrieved video segments;

FIG. 11 illustrates a system for distributing segmented immersive video; and

FIG. 12 illustrates an alternative system for distributing segmented immersive video, this system including a distribution server.

### DETAILED DESCRIPTION

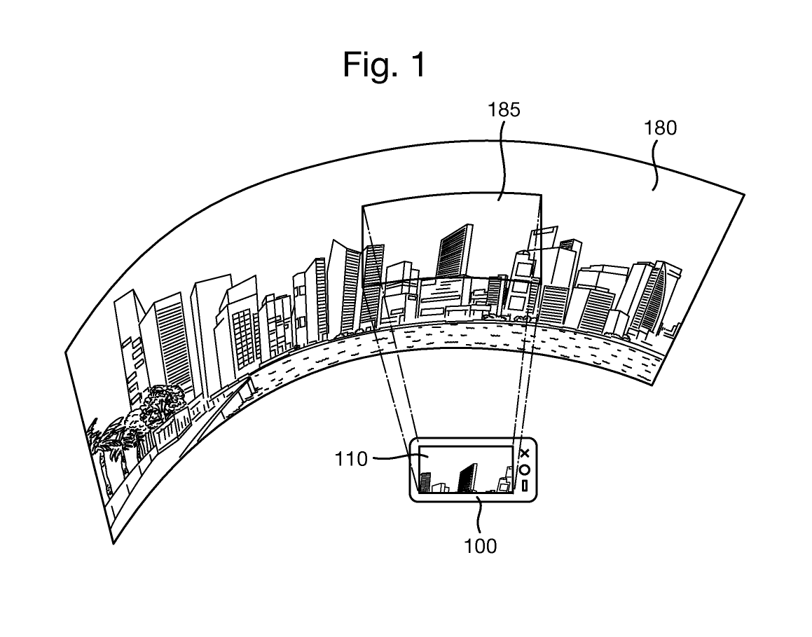

FIG. 1 illustrates a user terminal 100 displaying a portion of an immersive video 180. The user terminal is shown as a smartphone and has a screen 110, which is shown displaying a selected portion 185 of immersive video 180. In this example immersive video 180 is a panoramic or cylindrical view of a city skyline.

Smartphone 100 comprises gyroscope sensors to measure its orientation, and in response to changes in its orientation the smartphone 100 displays different sections of immersive video 180. For example, if the smartphone 100 were rotated to the left about its vertical axis, the portion 185 of video 180 that is selected would also move to the left and a different area of video 180 would be displayed.

The user terminal 100 may comprise any kind of personal computer such as a television, a smart television, a set-top box, a games-console, a home-theatre personal computer, a tablet, a smartphone, a laptop, or even a desktop PC.

It is apparent from FIG. 1 that where the video 180 is stored remote from the user terminal 100, transmitting the video 180 in its entirety to the user terminal, just for selected portion 185 to be displayed is inefficient. This inefficiency is addressed by the system and apparatus described herein.

As described herein, an immersive video, such as video 180 is separated into a plurality of video segments, each video segment relating to a different area of a field of view of the received video stream. Each video segment is separately encoded.

The user terminal is arranged to select a subset of the available video segments, retrieve only the selected video segments, and to knit these together to form a knitted video image that is larger than a single video segment. Referring to the example of FIG. 1, the knitted video image comprises the selected portion 185 of the immersive video 180.

With modern viewing methods using a handheld device like a smartphone or a virtual reality headset, only a portion of the video is displayed at any one time. As such not all of the video must be delivered to the user to provide a good user experience.

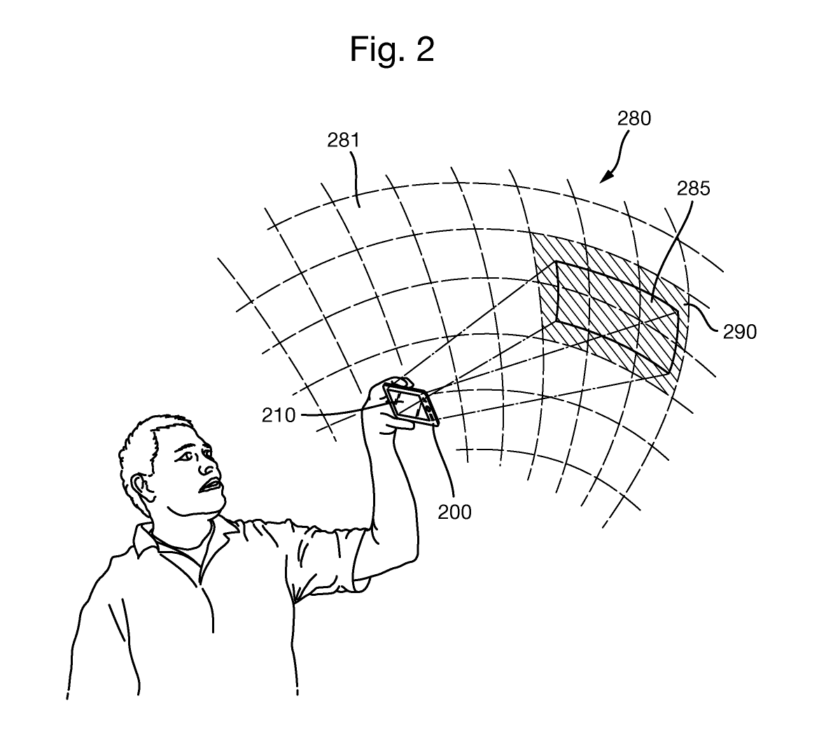

FIG. 2 shows a man watching a video 280 on his smartphone 200. Smartphone 200 has a display 210 which displays area 285 of the video 280. The video 280 is split into a plurality of segments 281. The segments 281 are illustrated in FIG. 2 as tiles of a sphere, representing the total area of the video 280 that is available for display by smartphone 200 as the user changes the orientation of this user terminal. The displayed area 285 of video 280 spans six segments or tiles 281. In this embodiment, only the six segments 290 which are included in displayed area 285 are selected by the user terminal for retrieval. Later in this document alternative embodiments will be described where additional segments are retrieved in addition to those needed to fill display area 285. These additional segments improve the user experience in certain conditions, while still allowing for reduced network resource consumption.

The selection of a subset of video segments by the user terminal is defined by a physical location and/or orientation of the user terminal. This information is obtained from sensors in the user terminal, such as a magnetic sensor (or compass), and a gyroscope. Alternatively, the user terminal may have a camera and use this together with image processing software to determine a relative orientation of the user terminal. The segment selection may also be based on user input to the user terminal. For example such a user input may be via a touch screen on the smartphone 200.

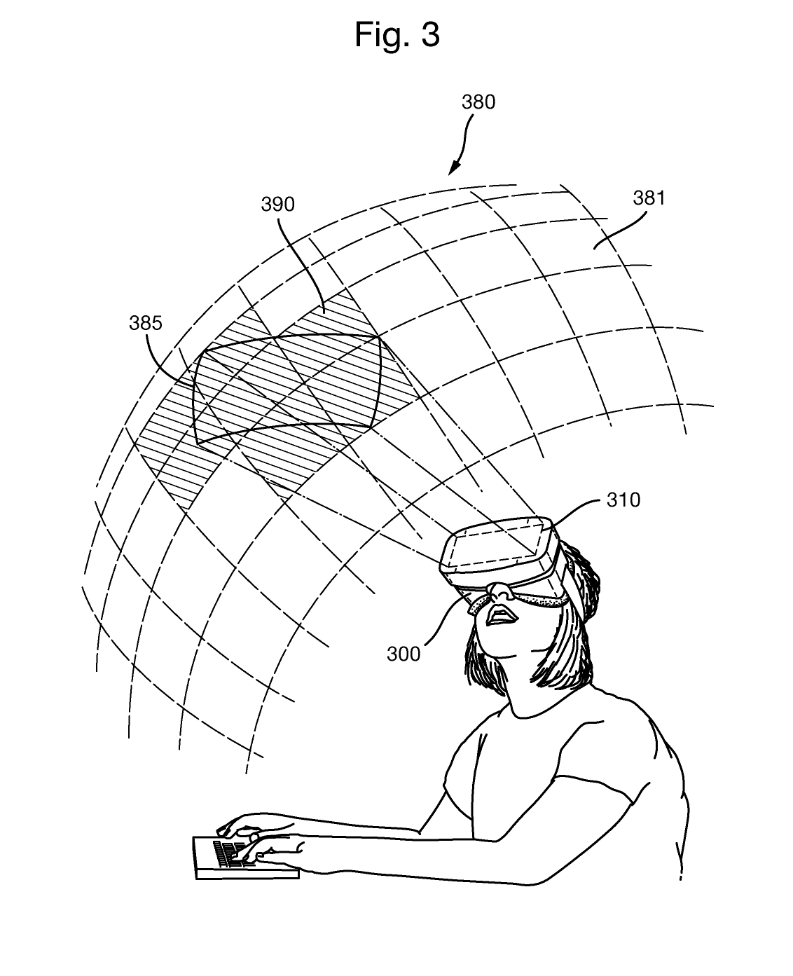

FIG. 3 shows a woman watching video 380 on a virtual reality headset 300. The virtual reality headset 300 comprises a display 310. The display 310 may comprise a screen, or a plurality of screens, or a virtual retina display that projects images onto the retina. Video 380 is segmented into individual segments 381. The segments 381 are again illustrated here as tiles of a sphere, representing which area of the video 280 may be selected for display by smartphone 280 as the user changes the orientation of her head, and also the orientation of the headset strapped to her head. The displayed area 385 of video 380 spans seven segments or tiles 381. These seven segments 390 which are included in displayed area 385 are selected by the headset for retrieval. The retrieved segments are decoded to generate individual video segments, and these are stitched or knitted together, from which the appropriate section 385 of the knitted video image is cropped and displayed to the user.

By allowing the user terminal to select and retrieve only a subset of the segments of an immersive video, the subset including those that are currently required for display to the viewer, the amount of information that the user terminal must retrieve and process to display the immersive video is reduced.

The segments in FIGS. 2 and 3 are illustrated as tiles of a sphere. Alternatively, the segments may comprise tiles on the surface of a cylinder. Where the segments relate to tiles of the surface of a cylinder, then the vertical extent of the immersive video is limited by the top and bottom edges of that cylinder. If the cylinder wraps fully around the user, then this may accurately be described as 360 degree video.

The selection of a subset of video segments by the user terminal is defined by a physical location and/or orientation of the headset 300. This information is obtained from gyroscope and/or magnetic sensors in the headset. The selection may also be based on user input to the user terminal. For example such a user input may be via a keyboard connected to the headset 300.

Segments 281, 381 of the video 280, 380 relate to a different field of view taken from a common location in either the real or virtual worlds. That is, the video may be generated by a device having a plurality of lenses pointing in different directions to capture different fields of view. Alternatively, the video may be generated from a virtual world, using graphical rendering techniques in a computer. Such graphical rendering may comprise using at least one virtual camera to translate the information of the three dimensional virtual world into a two dimensional image for display on a screen. Further, video segments 281, 381 relating to adjacent fields of view may include a proportion of view that is common to both segments. Such a proportion may be considered an overlap, or a field overlap. Such an overlap is not illustrated in the figures attached hereto for clarity.

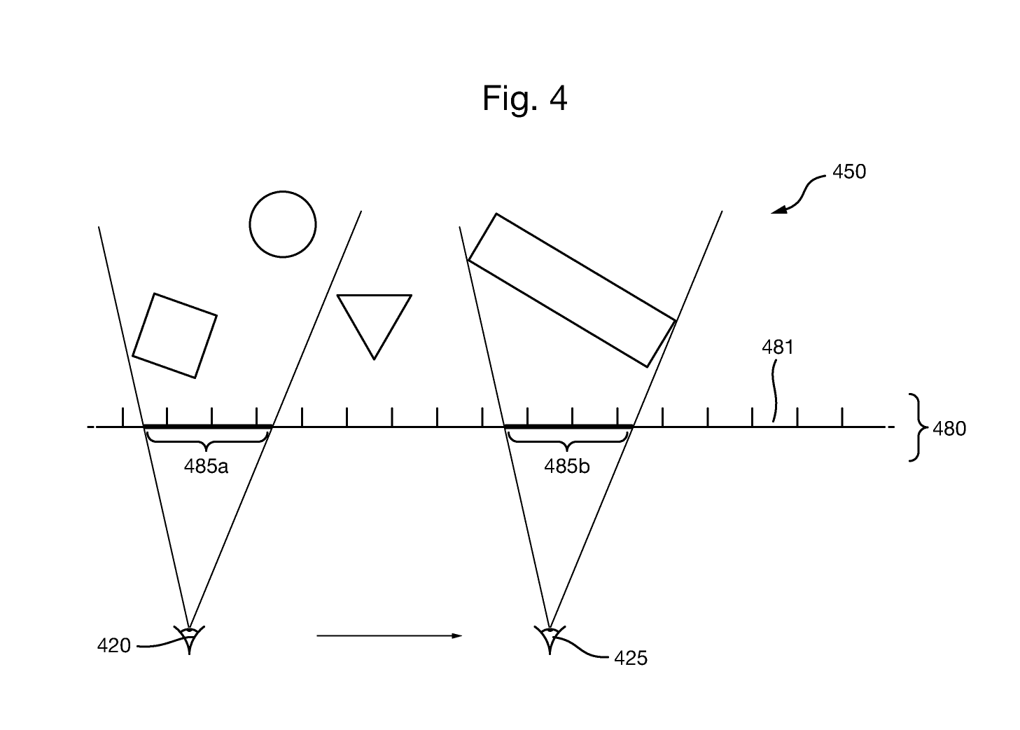

FIG. 4 illustrates an alternative arrangement wherein the video segments made available to the user terminal each relate to a different field of view taken from a different location. In such an arrangement each segment relates to a different point of view. The different location may be in either the real or virtual worlds. A plan view of such an arrangement is illustrated in FIG. 4. A video 480 is segmented into a grid of segments 481, a plan view of this is illustrated. At a first viewing position 420 the viewer sees display area 485a and the four segments that define that are required to show that area. The viewing position then moves, and at the new position 425 a different field of view 485b is shown to the user representing a sideways translation, side-step, or strafing motion within the virtual world 450. Transitioning from one set of segments to another thus gives the impression of a camera moving within the world.

Two examples are given above; FIG. 2 shows the user terminal as a smartphone 200, and FIG. 3 shows the user terminal as a virtual reality headset 300. In alternative embodiments the user terminal may comprises any one of a smartphone, tablet, television, set top box, or games console. Further, the above embodiments refer to the user terminal displaying a portion of an immersive video. It should be noted that the video image may be any large video image, such as a high resolution video, an immersive video, a “360 degree” video, or a wide-angled video. The term “360 degree” is sometimes used to refer to a total perspective view, but the term is a misnomer with 360 degrees only giving a full perspective view within one plane.

The plurality of video segments relating to the total available field of view, or total video area may each be encoded at different quality levels. In that case, the user terminal not only selects which video segments to retrieve, but also at which quality level each segment should be retrieved. This allows the immersive video to be delivered with adaptive bitrate streaming. External factors such as the available bandwidth and available user terminal processing capacity are measured and the quality of the video stream is adjusted accordingly. The user terminal selects which quality level of a segment to stream depending on available resources.

The quality level of an encoded video segment may be determined by the bit rate, the quantization parameter, or the pixel resolution. A lower quality segment should require fewer resources for transmission and processing. By making segments available at different quality levels, a user terminal can adapt the amount of network and processing resources it uses in much the same way as adaptive video streaming, such as adaptive bitrate streaming.

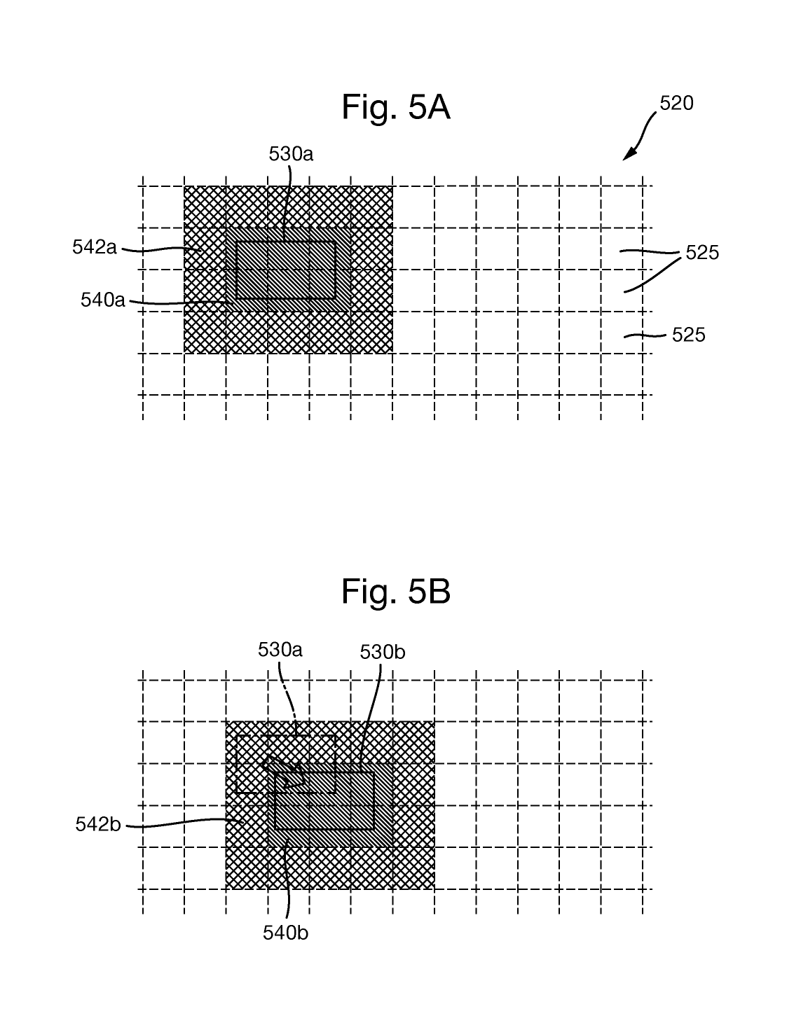

FIG. 5 shows a portion of a video 520 that has been sliced up into a plurality of video segments 525. FIG. 5a illustrates a first displayed area 530a, which includes video from six segments indicated with diagonal shading and reference 540a. In the above described embodiments only these six segments 540a are retrieved in order to display the correct section 530a of the video. However, when the user changes the selection, by for example moving the smartphone 200 or the virtual reality headset 300, the user terminal may not be able to begin streaming the newly required segments quickly enough to provide a seamless video stream to the user. This may result in newly panned to sections of the video being displayed as black squares while the segments that continue to be in view continue to be streamed by the user terminal. This will not be a problem in low latency systems with quick streaming startup.

Where this problem does occur, the effects can be mitigated by streaming auxiliary segments. Auxiliary segments are segments of video not required for displaying the selected video area but that are retrieved by the user terminal to allow prompt display of these areas should the selected viewing area change to include them. Auxiliary segments provide a spatial buffer. FIG. 5a shows fourteen such auxiliary segments in cross hatched area 542a. The auxiliary segments surround the six segments that are retrieved in order to display the correct section of the video 530a.

FIG. 5b, illustrates a change in the displayed video area from 530a to 530b. Displayed area 530b requires the six segments in area 540b. The area 540b comprises two of the six primary segments and four of the fourteen auxiliary segments from FIG. 5a, and can thus be displayed as soon as the selection is made with minimal lag. As soon as the new selection of display area 530b is made, the segment selections are updated. In this case a new set of six segments 540b is selected as primary segments, and a new set of fourteen auxiliary segments 542b is selected.

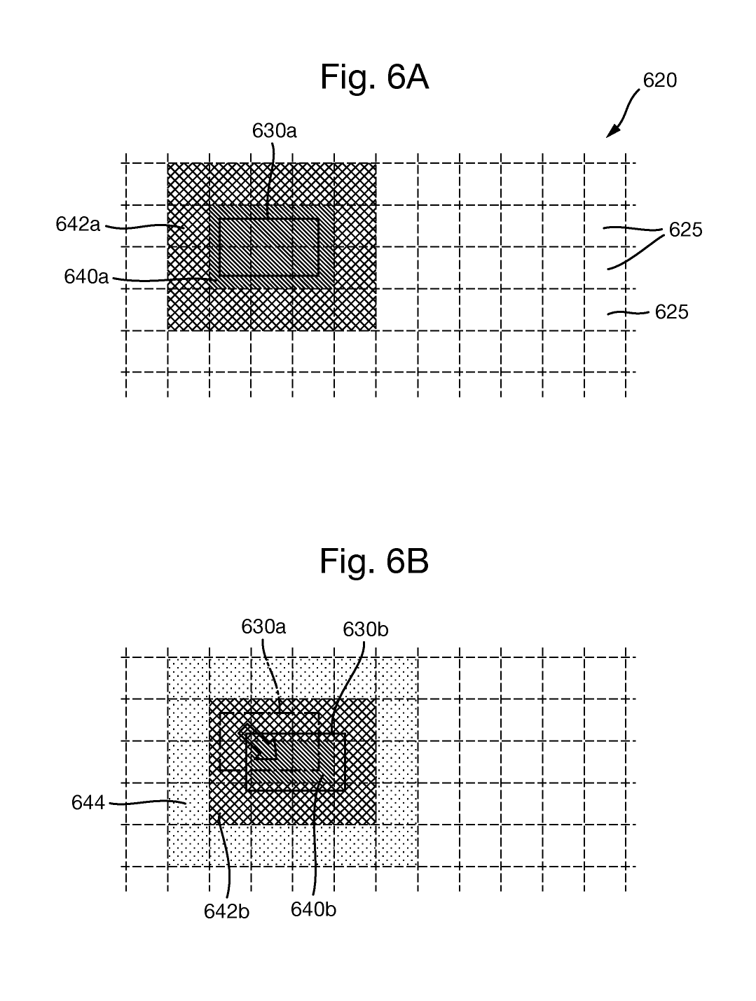

FIGS. 6a and 6b illustrate an alternative change in selection of displayed video area. Here, the newly selected video area 630b, includes only slim portions of the segments at the fringe, segments 642b. In this embodiment the system is configured to not require any additional auxiliary segments to be retrieved in this situation, with the streamed video area 640b plus 642b providing sufficient margin for movement of the selected video area 630. However, in a further alternative, or where network conditions allow, the eighteen segments in the dotted area 644 are additionally retrieved as auxiliary segments.

In an alternative embodiment, where segments are available at different quality levels, the segments shown in different areas in FIGS. 5 and 6 are retrieved at different quality levels. That is the primary segments in the diagonally shaded regions 540a, 540b, 640a, and 640b are retrieved in a relatively high quality, whereas the auxiliary segments in cross hatched regions 542a, 542b, 642a, and 642b are retrieved at a relatively lower quality. Where the secondary auxiliary segments in area 644 are downloaded, lower still quality versions of these are retrieved.

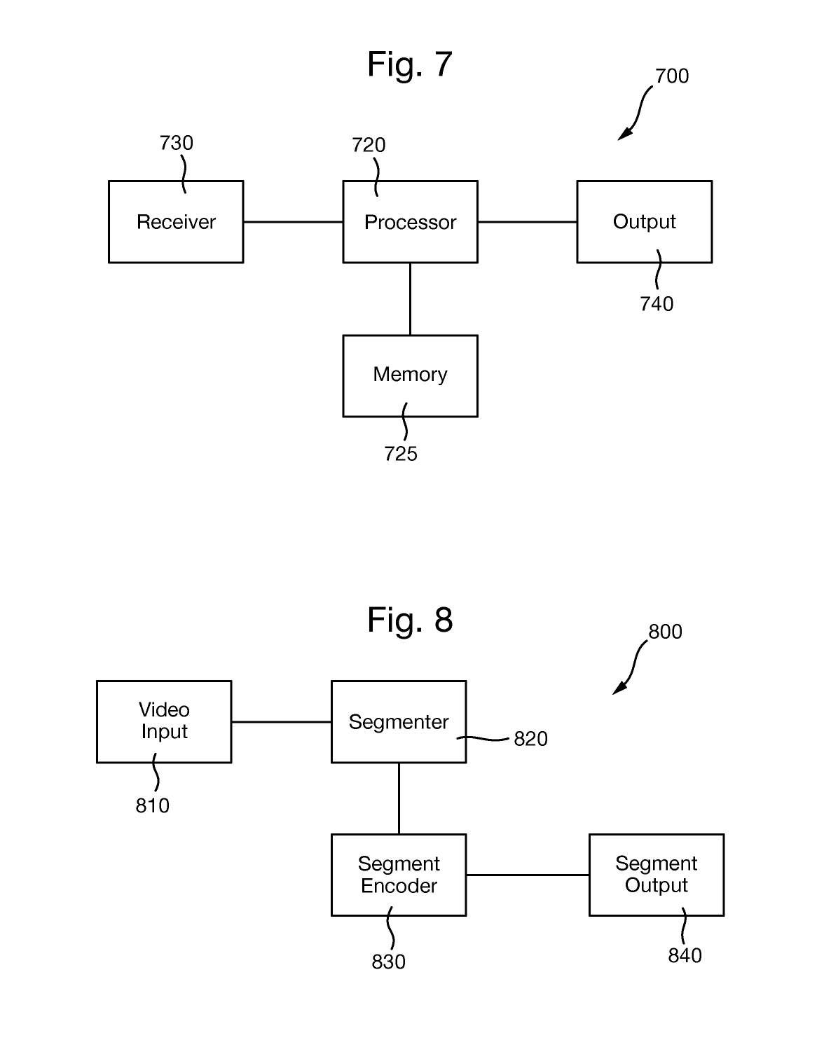

FIG. 7 shows an apparatus 700 arranged to output a portion of a large video image, the apparatus comprising a processor 720 and a memory 725, said memory 725 containing instructions executable by said processor 720. The processor 720 is arranged to receive instructions which, when executed, causes the processor 720 to carry out the method described herein. The instructions may be stored on the memory 725. The apparatus 700 is operative to select a subset of video segments each relating to a different area of a field of view, and retrieve the selected video segments via a receiver 730. The apparatus 700 is further operative to decode the retrieved segments and knit the segments of video together to form a knitted video image that is larger than a single video segment. The apparatus is further operative to output the knitted video image via output 740.

FIG. 8 shows a video processing apparatus 800 comprising a video input 810, a segmenter 820, a segment encoder 830, and a segment output 840. The video input 810 receives a video stream, and passes this to the segmenter 820 which slices the video stream into a plurality of video segments, each video segment relating to a different area of a field of view of the received video stream. Segment encoder 830 encodes each video segment, and may encode multiple copies of some segments, the multiple copies at different quality levels. Segment output 840 outputs the encoded video segments.

The received video stream may be a wide angle video, an immersive video, and/or high resolution video. The received video stream may be for display on a user terminal, whereby only a portion of the video is displayed by the user terminal at any one time. Each video segment may be encoded such that it can be decoded without reference to another video segment. Each video segment may be encoded in multiple formats, the formats varying in quality.

In one format a video segment may be encoded with reference to another video segment. In this case, at least one version of the segment is available encoded without reference to an adjacent tile, this is necessary in case the user terminal does not retrieve the referenced adjacent tile. For example, consider a tile “A” at location 1-1. In this case, the adjacent tile at location 1-2 is available in two formats: “B” a stand-alone encoding of location 1-2; and “C” an encoding that references tile “A” at location 1-1. Because of the additional referencing tile “C” is more compressed or of higher quality than tile “B”. If the user terminal has downloaded “A” then it could choose to pick “C” instead of “B” as this will save bandwidth and/or give better quality.

By splitting an immersive video into segments and encoding each segment separately, the video processing apparatus creates a plurality of discrete files suitable for subsequent distribution to a user terminal whereby only the tiles that are needed to fill a current view of the user terminal must be sent to the user terminal. This reduces the amount of information that the user terminal must retrieve and process for a particular section or view of the immersive video to be shown. As described above, additional tiles (auxiliary segments) may also be sent to the user terminal in order to allow for responsive panning of the displayed video area. However, even where this is done there is a significant saving in the amount of video information that must be sent to the user terminal when compared against the total area of the immersive video.

The video processing apparatus outputs the encoded video segments. The video processing apparatus may receive the user terminal selection of segments and outputs the video segments selected by a user terminal to that user terminal. Alternatively, the video processing apparatus may output all encoded video segments to a distribution server, for subsequent distribution to at least one user apparatus. In that case the distribution server receives the user terminal selection of segments and outputs the video segments selected by a user terminal to that user terminal.

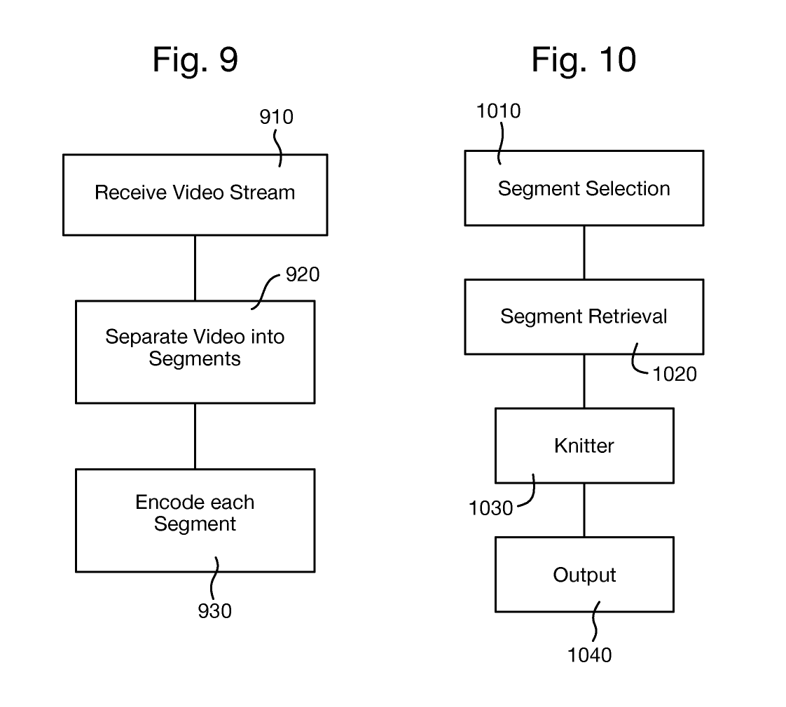

FIG. 9 illustrates a method in a video processing apparatus. The method comprises receiving 910 a video stream, and separating 920 the video stream into a plurality of video segments, each video segment relating to a different area of a field of view of the received video stream. The method further comprises encoding 930 each video segment.

FIG. 10 illustrates a method of processing retrieved video segments. This method may be performed in the user apparatus described above. The method comprises making a selection 1010 a subset of the available video segments. The selection may be based on received user input or device status information. The method further comprises retrieving 1020 the selected video segments, and knitting 1030 these together to form a knitted video image that is larger than a single video segment. The knitted video image is then output 1040 to the user.

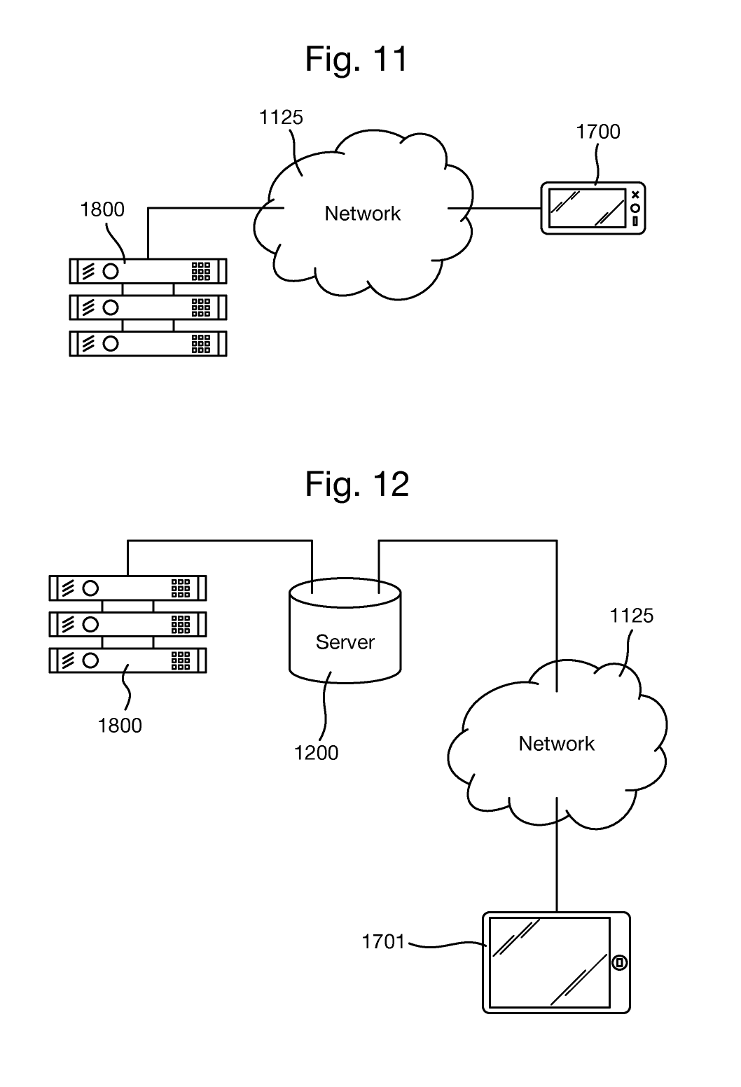

FIG. 11 illustrates a system for distributing segmented immersive video. A video processing apparatus 1800 segments and encodes video, and transmits this via a network 1125 to at least one user device 1700, in this case a smartphone. The network 1125 is an internet protocol network.

FIG. 12 illustrates an alternative system for distributing segmented immersive video, this system, including a distribution server 1200. A video processing apparatus 1800 segments and encodes video, and sends these to a distribution server 1200. The distribution server stores the encoded segments ready to serve them to a user terminal upon demand. When required, the distribution server 1200 transmits the appropriate segments via a network 1125 to at least one user device 1701, in this case a tablet computer.

Where the video processing apparatus merely outputs all encoded versions of the video segments to a server, the server may operate as a transmission apparatus. The transmission apparatus is arranged to receive a selection of video segments from a user terminal, the selected video segments suitable for being knitted together to create an image that is larger than a single video segment. The transmission apparatus is further arranged to transmit the selected video segments to the user device.

The transmission apparatus may record which video segments are requested, for gathering statistical information such as segment popularity.

The popularity of particular segments, and how this varies with time, can be used to target the encoding effort on the more popular segments. Where the video processing apparatus has a record of the popularity of each video segment, this will give a better quality experience to the majority of users for a given amount of encoding resource. The popularity may comprise an expected value of popularity, a statistical measure of popularity, and/or a combination of the two. The received video stream may comprise live content or pre-recorded content, and the popularity of these may be measured in different ways.

For live content, the video processing apparatus uses current viewer's requests for segments as an indication of which segments will be most likely to be downloaded next. This bases the assessment of segments that will be popular in future on the positions of currently popular segments. This assumes that the locations of popular segments will remain constant.

For pre-recorded content, a number of options are available, two of which will be described here. The first is video analysis before encoding. Here the expected popularity may be generated by analyzing the video segments for interesting features such as faces or movement. Video segments containing such interesting features, or that are adjacent to segments containing such interesting features are likely to be more popular than other segments. The second option is two pass encoding with the second pass based on statistical data. The first pass creates segmented deliverable content that is delivered to users, and their viewing areas or segment downloads analyzed. This information is used to generate a measure of segment popularity which is used to target encoding resources in a second pass of encoding. The results of the second pass encoding used to distribute the segmented video to subsequent viewers.

The output of the above popularity assessment measures can be used by the video processing apparatus to apply more compression effort to the video segments having the highest popularity. A greater compression effort results in a more efficiently compressed video segment. This gives a better quality video segment for the same bitrate, a lower bitrate for the same quality of video segment, or a combination of the two. However, increased compression effort requires more processing resources. For example, multiple pass encoding requires significantly more processing resource than a single pass encode. In many situations, applying such resource intensive video processing to the low popularity segments will be an inefficient use of available encoding capacity, and so identifying the more popular segments allows these resources to be implemented more efficiently.

The video stream can be sliced into a plurality of video segments dependent upon the content of the video stream. For example, where an advertiser's logo or channel logo appears on screen the video processing apparatus may slice the video such that the logo appears in one segment.

Further, where the video processing apparatus has a record of the popularity of each video segment, then popular and adjacent video segments can be combined into a single larger video segment. Larger video segments might be encoded more efficiently, as the encoder has a wider choice of motion vectors, meaning that an appropriate motion vector candidate is more likely to be found. Also, popular video segments relating to adjacent fields of view are likely to be viewed together and so requested together. It is possible that a visual discontinuity will be visible to a user where adjacent segments meet. Merging certain segments into a large segment allows the segment boundaries within the larger segment to be processed by the video processing apparatus and thus any visual artefacts can be minimized. Another way to achieve the same benefits is for the video processing apparatus to keep a record of video segments that are downloaded together and combine those video segments accordingly.

In a further embodiment, each video segment is assigned a commercial weighting, and more compression effort is applied to the video segments having the highest commercial weighting. The commercial weighting of a video segment may be determined by the presence of an advertisement or product placement within the segment.

There is further provided a computer-readable medium, carrying instructions, which, when executed by computer logic, causes said computer logic to carry out any of the methods defined herein. There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

The above embodiments have been described with reference to two dimensional video. The techniques described herein are equally applicable to stereoscopic video, particularly for use with stereoscopic virtual reality displays. Such immersive stereoscopic video is treated as two separate immersive videos, one for the left eye and one for the right eye, with segments from each video selected and knitted together as described herein.

As well as retrieving video segments for display, the user terminal may be further arranged to display additional graphics in front of the video. Such additional graphics may comprise text information such as subtitles or annotations, or images such as logos, highlights. The additional graphics may be partially transparent. The additional graphics may have their location fixed to the immersive video, appropriate in the case of a highlight applied to an object in the video. Alternatively, the additional graphics may have their location fixed in the display of the user terminal, appropriate for a channel logo or subtitles.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope

The examples of adaptive streaming described herein, are not intended to limit the streaming system to which the disclosed method and apparatus may be applied. The principles disclosed herein can be applied using any streaming system which uses different video qualities, such as HTTP Adaptive Streaming, Apple™ HTTP Live Streaming, and Microsoft™ Smooth Streaming.

Further, while examples have been given in the context of a particular communications network, these examples are not intended to be the limit of the communications networks to which the disclosed method and apparatus may be applied. The principles disclosed herein can be applied to any communications network which carries media using streaming, including both wired IP networks and wireless communications networks such as LTE and 3G networks.

1. A user terminal arranged to:
Select, from a plurality of video segments, a subset of video segments each relating to a different area of a field of view;
retrieve the selected video segments;
knit the selected segments together to form a knitted video image that is larger than a single video segment; and
output the knitted video image.

2. The user terminal of claim 1, wherein the plurality of video segments relating to the total available field of view are encoded at different quality levels, and the user terminal further selects a quality level of each selected video segment that is retrieved.

3. The user terminal of claim 1, wherein the selection of a subset of video segments is defined by a physical location and/or orientation of the user terminal.

4. The user terminal of claim 1, wherein the selection of a subset of video pixels is defined by user input to a controller connected to the user terminal.

5. The user terminal of claim 1, wherein the user terminal comprises at least one of a smart phone, tablet, television, set top box, or games console.

6. The user terminal of claim 1, wherein the user terminal is arranged to display a portion of a large video image.

7. An apparatus arranged to display a portion of a large video image, the apparatus comprising:
a processor; and
a memory, said memory containing instructions executable by said processor whereby said apparatus is operative to:
select a subset of video segments each relating to a different area of a field of view;
retrieve the selected video segments;
knit the selected segments together to form a knitted video image that is larger than a single video segment; and
output the knitted video image.

8. A video processing apparatus arranged to:
receive a video stream;
slice the video stream into a plurality of video segments, each video segment relating to a different area of a field of view of the received video stream; and
encode each video segment.

9. The video processing apparatus of claim 8, wherein the video processing apparatus has a record of the popularity of each video segment.

10. The video processing apparatus of claim 9, wherein the video processing apparatus applies more compression effort to the video segments having the highest popularity.

11. The video processing apparatus of claim 8, wherein the video stream is sliced into a plurality of video segments dependent upon the content of the video stream.

12. The video processing apparatus of claim 11, wherein the video processing apparatus has a record of the popularity of each video segment, and whereby popular video segments relating to adjacent fields of view are combined into a single larger video segment.

13. The video processing apparatus of claim 8, wherein each video segment is assigned a commercial weighting, and effort higher compression level is applied to the video segments having the highest commercial weighting.

14. A transmission apparatus arranged to:
receive a selection of video segments from a user terminal, the selected video segments suitable for being knitted together to create an image that is larger than a single video segment;
transmit the selected video segments to the user device.

15. The transmission apparatus of claim 14 further arranged to record which video segments are requested.
